(19) United States
(12) Patent Application Publication
(10) Pub. No.: US 2017/0345265 A1
(43) Pub. Date: Nov. 30, 2017

(54) DYNAMIC ACQUISITION TERMINAL FOR BEHAVIOR STATISTIC INFORMATION OF PEOPLE, EVACUATION SYSTEM AND METHOD

(71) Applicants: Carrier Corporation, Farmington, CT (US); GULF SECURITY TECHNOLOGY COMPANY LIMITED, Hebei (CN)

(72) Inventors: Jianwei Zhao, Shanghai (CN); Bill Li, Beijing (CN); Robert Hong-Leung Chiang, Manlius, NY (US); Hairun Wang, Hebei (CN); Aizhong Wang, Shenzhen (CN); Qiang Li, Shanghai (CN)

(21) Appl. No.: 15/524,462

(22) PCT Filed: Oct. 30, 2015
(86) PCT No.: PCT/US2015/058213

§ 371 Date: May 4, 2017

(30) Foreign Application Priority Data
Nov. 7, 2014 (CN) 201410620988.1

(51) Int. Cl. G08B 7/06; G06K 9/00

(52) U.S. Cl. CPC G08B 7/062; G08B 7/066; G06K 9/00778; G06K 2009/00738

(57) ABSTRACT

A dynamic acquisition terminal for behavior statistic information of people in a building and an evacuation system and method. The dynamic acquisition terminal for behavior statistic information comprises a sensor, used for directly acquiring video information or audio and video information of people in the building; and an analysis component, used for performing analysis processing to the video information or audio and video information to dynamically generate people's behavior statistic information data. The evacuation system comprises a plurality of dynamic acquisition terminals for behavior statistic information; an escape route generation device, used for dynamically optimizing generation of an escape route at least based on the people's behavior statistic information data transmitted by the dynamic acquisition terminals for behavior statistic information; and an evacuation indicating system, used for dynamically generating and displaying evacuation sign information at least based on the escape route.

### FIELD OF THE INVENTION

The present invention belongs to the technical field of intelligent escape in buildings and relates to a dynamic acquisition terminal for behavior statistic information of people installed in a building, and an evacuation system and method for dynamically and optimally generating an escape route based on the dynamic behavior statistic information of people acquired by the terminal.

### BACKGROUND OF THE INVENTION

As floors of buildings are increasing and high-rise buildings are more and more, when sudden accidents (such as fire, earthquake and terrorist attack) happen, whether a great number of people in the buildings can safely, quickly and effectively escape or not becomes very important. Therefore, people increasingly concern about the intelligent evacuation technique of buildings.

The existing intelligent evacuation system can receive input information coming from a fire alarm system and can compute the relatively shortest escape route based on information such as static 3D route information, so as to display it through indicating devices to guide people in the building to quickly evacuate or guide rescuers to quickly rescue and to achieve the goal of high-efficiency escape. Although the evacuation route generated through computation may theoretically the shortest, since actual dynamically changing factors are not considered, especially dynamically changing factors such as whether fire doors are closed or not, whether the route is blocked or not and whether elevators function normally or not caused by behavior subjectivity of people are not considered and the blockage or crowdedness of the route caused by dynamic change of behaviors of people is not further considered at all, the statically generated shortest escape route is usually not the most effective in the actual escape process. In the aspect of guiding people in the building, the evacuation/rescue system cannot realize the goals of safety, quickness and effectiveness in the actual process.

### SUMMARY OF THE INVENTION

The purpose of the present invention is to enable the evacuation/rescue of people in buildings to become safer, quicker and more effective.

In order to realize the above-mentioned purpose or other purposes, the present invention provides the following technical solution.

According to one aspect of the present invention, the present invention provides a dynamic acquisition terminal for behavior statistic information of people in a building, which comprises:

a sensor, used for directly acquiring video information or audio and video information of people in the building; and

an analysis component, used for performing analysis processing to the video information or audio and video information to dynamically generate people's behavior statistic information data.

According to another aspect of the present invention, the present invention provides a detector, in which the above-mentioned dynamic acquisition terminal for behavior statistic information of people in the building is integrated and arranged.

According to another aspect of the present invention, the present invention provides an evacuation system, which comprises:

a plurality of dynamic acquisition terminals for behavior statistic information of any kind as described above;

an escape route generation device, used for dynamically and optimally generating an escape route at least based on the people's behavior statistic information data transmitted by the dynamic acquisition terminals for behavior statistic information; and an evacuation indicating system, used for dynamically generating and displaying evacuation sign information at least based on the escape route.

According to another aspect of the present invention, the present invention provides an evacuation method, which comprises the following steps:

acquiring video information or audio and video information of people in a building;

performing analysis processing to the video information or audio and video information to dynamically generate people's behavior statistic information data;

dynamically and optimally generating an escape route at least based on the people's behavior statistic information data; and

dynamically generating and displaying evacuation sign information based on the escape route.

### DESCRIPTION OF THE DRAWINGS

The above-mentioned and other purposes and advantages of the present invention will become more complete and clear in the following detailed description in combination with the drawings, in which the same or similar elements are indicated by the same mark signs.

FIG. 1 is a schematic diagram of a modular structure of an evacuation system according to one embodiment of the present invention.

FIG. 2 is a schematic structural diagram of a dynamic acquisition terminal for behavior statistic information of people in a building according to one embodiment of the present invention.

FIG. 3 is a schematic diagram of a basic principle of dynamically updating and generating an optimum escape route.

FIG. 4 is a schematic diagram of a flow of an evacuation method according to one embodiment of the present invention.

### DESCRIPTION OF THE EMBODIMENTS

Some of multiple possible embodiments of the present invention will be introduced below, aiming at providing basic understanding to the present invention instead of confirming key or critical elements of the present invention or limiting the range to be protected. It can be easily understood that one skilled in the art can provide mutually replaceable other embodiments according to the technical solution of the present invention without changing the substantive spirit of the present invention. Therefore, the specific embodiments and drawings described below are merely exemplary descriptions to the technical solution of the present invention, and should not be deemed as all of the present invention or as restrictions or limitations to the technical solution of the present invention.

In the present application, buildings can include any type of buildings, facilities, residences, shelters or other places which are suitable for activities of human, and can also include a set of structures similar to the buildings and the facilities, such as a set of a plurality of structures in campuses and towns. Moreover, it is to be noted that, in the present application, “buildings” are not limited to buildings above the ground, and any other places underground such as metro stations which are suitable for activities of human also fall into the definition range of “buildings” in the present application.

In the description below, for the sake of clarity and simplicity of the description, a plurality of components as shown in the drawings are not completely described in detail, and the plurality of components as shown in the drawings provide one ordinary skilled in the art with contents which can be used for completely realizing the present invention.

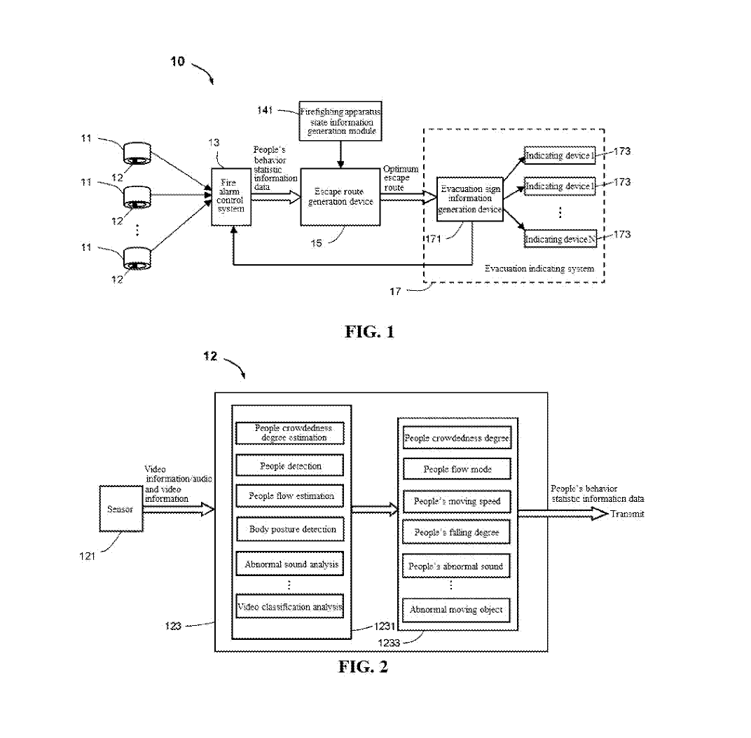

FIG. 1 is a schematic diagram of a modular structure of an evacuation system according to one embodiment of the present invention. As shown in FIG. 1, in the evacuation system 10 according to this embodiment of the present invention, the optimum escape route is dynamically computed at least based on dynamically acquired behavior statistic information of people in a building, and thus a plurality of dynamic acquisition terminals 12 for behavior statistic information of people installed in the building need to be configured therein. In this embodiment, optionally, the dynamic acquisition terminals 12 for behavior statistic information of people and detectors 11 (such as typical smoke sensing fire detectors) installed in the building are integrated together, thereby the decrease of the manufacturing cost of the terminals 12 is facilitated and the installation is facilitated. The detectors 11 can be various fire detectors, such as smoke detectors and typical smoke sensing fire detectors. The specific functions of the detectors 11 are not limited in the present invention and can be defined according to the requirements on data acquisition of fire alarm systems. The dynamic acquisition terminals 12 for behavior statistic information of people can specially include camera devices in this embodiment, which can acquire video information (i.e., original video information) in real time, or can acquire audio and video information (i.e., original audio and video information) in real time. Thereby, the dynamic acquisition terminals 12 for behavior statistic information of people can acquire the video information or audio and video information of people within a range monitored thereby through the camera devices. The dynamic acquisition terminals 12 for behavior statistic information of people further perform analysis processing to the video information or audio and video information to obtain people's behavior statistic information data needed by the evacuation system 10 for dynamically computing the optimum escape route.

The dynamic acquisition terminals 12 for behavior statistic information of people can be installed and fixed in the building at positions such as evacuation node key positions at which the behaviors of people can be easily monitored when sudden accidents happen. However, it should be understood that the installation and fixing positions thereof are not limited by the embodiment of the present invention. In addition, the fixing and installation positions of the dynamic acquisition terminals 12 for behavior statistic information of people in the building are recorded in the evacuation system 10, such that the behavior statistic information data of the people at all corresponding evacuation nodes can be acquired.

FIG. 2 is a schematic structural diagram of a dynamic acquisition terminal for behavior statistic information of people in a building according to one embodiment of the present invention. The basic structure and principle of the dynamic acquisition terminal 12 for behavior statistic information of people according to the embodiment of the present invention will be described below in combination with FIG. 2.

In this embodiment, the dynamic acquisition terminal 12 for behavior statistic information of people mainly comprises a sensor 121 and an analysis component 123. The sensor 121 specifically can be a sensor of any kind such as a camera device which can acquire video information or audio and video information of people. When the terminal 12 is integrated and arranged in the detector 11, the sensor 121 can be installed on a base of the detector 11. The video information or audio and video information is transmitted to the analysis component 123 for intelligent analysis processing. The analysis component 123 can be implemented by means of a processor chip installed in the terminal 12 or can be implemented by sharing a processor chip with the detector 11.

In one embodiment, the analysis component 123 comprises an information analysis processing subcomponent 1231 and a data generation subcomponent 1233, wherein the analysis processing subcomponent 1231 is used for performing analysis processing to the received video information or audio and video information, such as video information analysis processing and/or audio and video information analysis processing. The analysis processing includes, but not limited to, crowdedness degree estimation, people detection, people flow estimation, body posture detection (such as detection of normal body postures and/or abnormal body postures), abnormal sound analysis and/or video classification analysis. Thereby, after being analyzed, a great amount of unrelated information in image information or audio information is filtered and abandoned to save transmission bandwidth, fully protect personal privacy and facilitate the quick generation of people's behavior statistic information data in the data generation subcomponent 1233; the generated people's behavior statistic information data include, but not limited to, people crowdedness degree, people flow mode, people's moving speed, people's falling degree, people's abnormal sound and/or abnormal moving objects, etc. In one embodiment, in the analysis processing process, people's behavior information extracted from the video information or audio and video information and the analysis processing result of the analysis processing subcomponent 1231 are further statistically collected and computed to obtain the people's behavior statistic information data, such as number of people obtained through statistics and people crowdedness degree obtained through statistics. Thereby, the generated people's behavior statistic information data are greatly simplified relative to the input video information or audio and video information, which is reflected by that the number of occupied bytes is greatly reduced, such that a transmitting component (not shown) of the terminal 12 can quickly and dynamically transmit the people's behavior data to a main controller of the evacuation system 10 for processing, the wired or wireless bandwidth required for data transmission is small and the wiring and laying become easier.

It needs to be understood that the people's behavior statistic information data obtained by the analysis component 123 include people's behavior statistic information data obtained through analysis of a frame of video information or audio and video information (i.e., video information or audio and video information at a certain time point) and statistic computation from the angle of space (i.e., space domain), such as the number of people at certain time point obtained through statistics; and also include people's behavior statistic information data obtained through statistic computation after analysis of a plurality of continuous frames of video information or audio and video information for a certain time period (i.e., time domain), such as the number of people for a certain time period obtained through statistics, such that a people flow mode can be obtained. Therefore, in the present application, the people's behavior statistic information data can be obtained through statistic computation processing in space domain or time domain.

It needs to be understood that the analysis component 123 can realize the above-mentioned analysis processing and generation process based on the existing any video image analysis processing technique and/or audio analysis processing technique, such as an analysis method of behaviors of people in Chinese patent with application number CN201410016292.8, entitled “Self-adaptive Group Abnormal Behavior Analysis Method”, which is hereby incorporated herein in its entirety by reference.

It needs to be stated that the people's behavior statistic information data generated by the analysis component 123 can include number information of people, such as current number of escape people at a certain evacuation node. Number information of relevant people can be obtained during crowdedness degree estimation analysis.

It needs to be stated that, in the dynamic acquisition terminal 12 for behavior statistic information of people in this embodiment, the video information or audio and video information received thereby is real-time and dynamic, the analysis processing and generation process is also dynamically performed in real time and thereby the people's behavior statistic information data can be dynamically transmitted in real time.

In another embodiment, the video information or audio and video information acquired by the dynamic acquisition terminal 12 for behavior statistic information of people is used in the analysis processing process. After analysis processing, the terminal 12 does not store any of the video information or the audio and video information. Therefore, the terminal 12 therein is not provided with a memory for storing the video information or the audio and video information. Thereby, the problem that the privacy of people whose images are captured is invaded can be avoided, and the acceptability of the terminal 12 and/or the evacuation system 10 for users is improved. Of course, it needs to be understood that temporary storage may occur during the analysis processing of the video information or audio and video information. For example, a buffer portion in the processor chip of the analysis component 123 is used for storing part of the video information or audio and video information subjected to the analysis processing, and the contents stored by the buffer portion will be overwritten by video information or audio and video information which is subsequently acquired and needs to be subjected to analysis processing. Therefore, such similar buffer means should be not understood as memories described above for storing the video information or audio and video information.

Continuously as shown in FIG. 1, the evacuation system 10 comprises an escape route generation device 15, which can be arranged in the main controller of the evacuation system 10. In this embodiment, the people's behavior statistic information data output by the terminal 12, together with other types of data detected by the detector 11, can be transmitted to a fire alarm control system 13 in the building, and then are transmitted to the escape route generation device 15 through the fire alarm control system 13 after the fire alarm control system 13 determines to trigger an alarm. The transmission of the data can be implemented in a wired or wireless manner.

In one embodiment, the fire alarm control system 13 can also transmit the received people's behavior statistic information data to displaying devices controlled thereby and corresponding people's behavior statistic information data are intuitively displayed, for example, by display screens in the building. Thereby, the direct acquisition of the behavior statistic information of people at each evacuation node by escape people or rescuers is facilitated, and beneficially people who are familiar with internal building routes can quickly make subjective judgments on escape routes.

Further, the escape route generation device 15 not only can dynamically acquire the people's behavior statistic information data, but also can acquire dynamic information of states of key apparatuses needed for escape in the building in this embodiment, such as firefighting apparatus state information. Therefore, the escape route generation device 15 can receive information from a firefighting apparatus state information generation module 141, such as state information of fire doors and elevator state information. Of course, the fire alarm control system 13 is not limited to transmit the people's behavior statistic information data. For example, smoke and fire spreading information data detected by the detector 11 can also be transmitted to the escape route generation device 15. Various dynamic information data, especially people's behavior statistic information data can be used for dynamically updating the optimum escape route.

It also should be understood that, in the process of dynamically computing the optimum escape route, the escape route generation device 15 can also acquire other static data, such as length and width information of an escape route, planar and vertical route network, a building's 3D route network and a static escape node distribution map, and can generate initial escape route costs based on such static data.

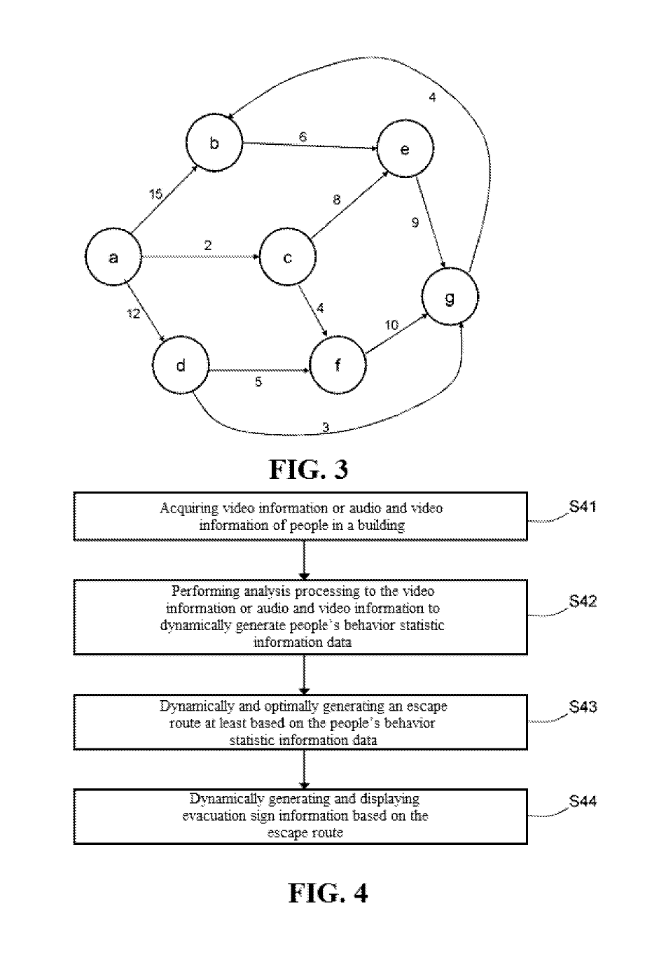

The basic principle of dynamically generating the optimum escape route will be exemplarily described below in combination with FIG. 3.

In this embodiment, the optimum escape route is computed based on a shortest route algorithm. Specifically, the optimum escape route such as the shortest route from a starting point (such as a room or a corridor) to all other exits (such as stairs or escape elevators) is exemplarily computed based on Dijkstra algorithm. The Dijkstra algorithm mainly has the feature of outwards extending layer by layer by taking a starting point as a center until all exits are traversed such that a route at the smallest cost is selected as the optimum escape route.

As shown in FIG. 3, exemplary vertexes a, b, c, d, e, f and g in FIG. 3 stand for route nodes in the building (i.e., joint points of two or multiple routes), and can also be understood as evacuation nodes. Supposing that point a is a starting point, point f is an escape exit node, a cost function D is introduced herein, D(xy) expresses a cost from point x to point y, and D values between adjacent nodes of vertexes a, b, c, d, e, f and g under static conditions (which can be understood as ideal conditions) can be obtained through computation based on the above-mentioned static data. Therefore, under the situation of not considering dynamically changing factors, the minimum value of D(af) between vertexes a and f is D(ac)+D(cf)=2+4=6, expressing that the minimum cost of the route from point a to point f is 6. Therefore, under ideal situations, the optimum escape route of point a is a→c→f.

In the computation of the optimum escape route in the present invention, the influence of the people's behavior statistic information data on the route cost is considered. For example, according to the people's behavior statistic information data, the people crowdedness degree on the current escape route, the direction and speed of escape people flow and the like can be known in real time. For different people's behavior statistic information data, the route cost D will be dynamically corrected according to different weights. The specific correction method is that, for example, the cost D will become greater under the situations of more crowded people, lower people flow speed and more inconsistent people flow direction. For example, under static conditions, the route between points a-c is very short (D(ac)=2). However, since the people are crowded and there are people who are running in a direction from point c to point a, the controller of the escape route generation device 15 quickly and dynamically changes the cost D(ac) of the route a-c to 20, the controller immediately obtains that the minimum value of D(af) between point a and point f at current is D(ad)+D(df)=12+5=17 according to the changed D value, the optimum escape route from point a is changed to a→d→f and thereby the escape route is obviously optimized. In other words, the D value of the route takes the people's behavior statistic information data as functional variables and changes with the dynamic change of the people's behavior statistic information data. Therefore, the optimum escape route computed based on the shortest route algorithm will be dynamically changed.

It needs to be understood that the principle of dynamically updating the optimum escape route is just exemplarily described above, and the computation algorithm is not limited to the above-mentioned embodiment and can also be, for example, an Adaptive Ant Colony Algorithm, etc. The dynamic update of the optimum escape route is not limited to be based on the behavior dynamic information of people only. For example, firefighting apparatus state information from the module 141, and/or smoke and fire spreading information and the like from the fire alarm control system 13, etc. can also be used similarly for dynamically updating and generating the optimum escape route.

In the above-mentioned embodiment, the escape route is exemplarily optimized based on the shortest route algorithm. It needs to be understood that the optimization of the escape route is not limited to optimization based on the shortest route. In other embodiments, the escape route can also be similarly optimized based on a shortest time algorithm.

Continuously as shown in FIG. 1, the evacuation system 10 further comprises an evacuation indicating system 17. Escape route information generated by the escape route generation device 15 is transmitted to the evacuation indicating system 17. In this embodiment, the evacuation indicating system 17 comprises an evacuation sign information generation device 171 and a plurality of indicating devices 173. The evacuation sign information generation device 171 can be arranged in the main controller of the evacuation system and can receive the optimum escape route information, such that evacuation sign information can be dynamically generated and be correspondingly transmitted to the indicating devices 173 for display and people in the building can intuitively and dynamically acquire information indicating the optimum escape routes.

Each indicating device 173 (such as indicating device 1 to indicating device N) can be, but not limited to, indicating lamps and underground lamps and even various mobile display terminals, such as mobile phone terminals carried by people. The indicating devices 173 can be, but not limited to, installed at key points of each route.

In one embodiment, the evacuation sign information generated by the evacuation sign information generation device 171 can also be transmitted to the fire alarm control system 13, such that corresponding apparatuses can be controlled based on the evacuation sign information to facilitate the quick evacuation of the people. For example, the fire alarm control system 13 controls illuminating lamps corresponding to routes to be turned on for illumination based on the evacuation sign information, so as to facilitate the evacuation and escape of the people.

The evacuation system according to the embodiment as shown in FIG. 1 can generate the current optimum escape route based on the dynamic behavior statistic information of people, fully considers the influences of the factors of the escape people per se on the shortest routes, and very greatly facilitates the safe, quick and effective evacuation of people in the building under emergency conditions such as fires and earthquakes. In addition, the dynamic acquisition terminals for behavior statistic information can transmit relatively simple people's behavior statistic information data, the bandwidth required for data transmission is small, the quick update response of the escape routes according to the behaviors of the people at current is facilitated and the privacy of the people in the building is not invaded.

FIG. 4 is a schematic diagram of a flow of an evacuation method according to one embodiment of the present invention.

Firstly, step S41: acquiring video information or audio and video information of people in a building. This step is completed in the sensor 121 of the dynamic acquisition terminal 12 for behavior statistic information as shown in FIG. 2.

Further, step S42: performing analysis processing to the video information or audio and video information to dynamically generate people's behavior statistic information data. This step can be completed through the analysis component 123 of the dynamic acquisition terminal 12 for behavior statistic information as shown in FIG. 2. For the specific implementation, reference can be made to the specific description of the working principle of the analysis component 123 in the above-mentioned embodiment.

Wherein, the analysis processing includes, but not limited to, crowdedness degree estimation, people detection, people flow estimation, body posture detection, abnormal sound analysis and/or video classification analysis, etc. Thereby, after being analyzed, a great amount of unrelated information in image information or audio information is filtered and abandoned to facilitate the quick generation of people's behavior statistic information data; and the generated people's behavior statistic information data include, but not limited to, people crowdedness degree, people flow mode, people's moving speed, and/or people's falling degree, etc. In one embodiment, the people's behavior statistic information data can be obtained through further statistic computation of the above-mentioned analysis processing result, such as statistics of the number of people and statistics of people crowdedness degree. Thereby, the generated people's behavior statistic information data are greatly simplified relative to the input video information or audio and video information, which is reflected by that the number of occupied bytes is greatly reduced.

Step S41 and step S42 realize a process of a method for acquiring people's behavior statistic information data.

Further, step S43: dynamically and optimally generating an escape route at least based on the people's behavior statistic information data. This step can be completed in the escape route generation device 15 as shown in FIG. 1. For the specific implementation, reference can be made to the specific description of the working principle of the escape route generation device 15 in the above-mentioned embodiment.

It needs to be stated that, although the above-mentioned embodiment is described by taking the dynamic generation of the optimum escape route as an example, the optimum escape routes are generated under most situations in practical application; and it should be understood that the above-mentioned embodiment clearly and exemplarily reflects the concept of how to optimize the current escape routes. With respect to the degree of specific optimization, it can be configured according to the specific choices of users.

Further, step S44: dynamically generating and displaying evacuation sign information based on the escape route. This step can be completed through the evacuation indicating system 17 as shown in FIG. 1. For the specific implementation, reference can be made to the specific description of the working principle of the evacuation indicating system 17 in the above-mentioned embodiment.

Therefore, in the evacuation process of the people in the building, relatively preferred evacuation sign information can be dynamically displayed based on the behaviors of the people, and the safe, quick and effective evacuation of the people is facilitated.

In the present application, the evacuation system and/or evacuation method not only can be used for evacuation of people in buildings, but also can be used for rescue of people in buildings. It should be understood that the rescue by people outside can also be performed based on the optimum escape routes.

The above-mentioned examples mainly describe the dynamic acquisition terminal for behavior statistic information of people in the building and the evacuation system and the evacuation method using the terminal of the present invention. Although only some of the embodiments of the present invention are described, one ordinary skilled in the art should understand that the present invention can be implemented through many other embodiments without going beyond the concept and scope thereof, such as by independently manufacturing and installing the dynamic acquisition terminals 12 for behavior statistic information relative to the detectors 11, allocating the functions of the analysis components 123 of the dynamic acquisition terminals 12 for behavior statistic information into the fire alarm control system 13 and integrating the evacuation sign information generation device 171 and the escape route generation device 15 together. Therefore, the described examples and embodiments are not viewed as restrictive but exemplary. The present invention can cover various modifications and substitutions under the situation of not departing from the spirit and range of the present invention as defined by appended claims.

1. A dynamic acquisition terminal for behavior statistic information of people in a building, characterized in that the dynamic acquisition terminal for behavior statistic information of people comprises:
a sensor, used for directly acquiring video information or audio and video information of people in the building; and
an analysis component, used for performing analysis processing to the video information or audio and video information to dynamically generate people's behavior statistic information data.

2. The dynamic acquisition terminal for behavior statistic information of people according to claim 1, characterized in that the dynamic acquisition terminal for behavior statistic information is integrated in a detector.

3. The dynamic acquisition terminal for behavior statistic information of people according to claim 1, characterized in that the analysis component comprises:
an analysis processing subcomponent, used for performing analysis processing to the video information or audio and video information; and
a data generation subcomponent, used for generating the people's behavior statistic information data according to an analysis result.

4. The dynamic acquisition terminal for behavior statistic information of people according to claim 1, characterized in that the analysis processing includes crowdedness degree estimation, people detection, people flow estimation, body posture detection, abnormal sound analysis and/or video classification analysis.

5. The dynamic acquisition terminal for behavior statistic information of people according to claim 1, characterized in that the people's behavior statistic information data include people crowdedness degree, people flow mode, people's moving speed, people's falling degree, people's abnormal sound and/or abnormal moving objects.

6. The dynamic acquisition terminal for behavior statistic information of people according to claim 1, characterized in that the dynamic acquisition terminal for behavior statistic information further comprises:
a transmitting component, used for dynamically transmitting the people's behavior statistic information data.

7. The dynamic acquisition terminal for behavior statistic information of people according to claim 1, characterized in that after the video information or audio and video information is subjected to analysis processing, the terminal does not store any of the video information or audio and video information.

8. The dynamic acquisition terminal for behavior statistic information of people according to claim 1, characterized in that the people's behavior statistic information data are transmitted to a fire alarm control system.

9. A detector, characterized in that the dynamic acquisition terminal for behavior statistic information of people in the building according to claim 1 is integrated and arranged in the detector.

10. The detector according to claim 9, characterized in that the dynamic acquisition terminal for behavior statistic information comprises a sensor used for directly acquiring video information or audio and video information of people in the building, and the sensor is installed on a base of the detector.

11. An evacuation system, characterized in that the evacuation system comprises:
a plurality of dynamic acquisition terminals for behavior statistic information according to claim 1;
an escape route generation device, used for dynamically and optimally generating an escape route at least based on the people's behavior statistic information data transmitted by the dynamic acquisition terminals for behavior statistic information; and
an evacuation indicating system, used for dynamically generating and displaying evacuation sign information at least based on the escape route.

12. The evacuation system according to claim 11, characterized in that the evacuation system further comprises a fire alarm control system, the people's behavior statistic information data are transmitted to the fire alarm control system, and the firefighting control system transmits the people's behavior statistic information data to the escape route generation device after determining to trigger an alarm.

13. The evacuation system according to claim 11, characterized in that the evacuation system further comprises a firefighting apparatus state information generation module, which is used for dynamically transmitting firefighting apparatus state information to the escape route generation device; and the escape route generation device further dynamically and optimally generates the escape route at the same time based on the firefighting apparatus state information.

14. The evacuation system according to claim 11, characterized in that the escape route is computed based on a shortest route algorithm or a shortest time algorithm.

15. The evacuation system according to claim 11, characterized in that the evacuation indicating system comprises an evacuation sign information generation device and a plurality of indicating devices,
wherein the evacuation sign information generated by the evacuation sign information generation device is transmitted to the plurality of displaying devices.

16. The evacuation system according to claim 15, characterized in that the evacuation sign information generation device further transmits the evacuation sign information generated thereby to the fire alarm control system.

17. An evacuation method, characterized in that the evacuation method comprises the following steps:
acquiring video information or audio and video information of people in a building; performing analysis processing to the video information or audio and video information to dynamically generate people's behavior statistic information data;
dynamically and optimally generating an escape route at least based on the people's behavior statistic information data; and
dynamically generating and displaying evacuation sign information based on the escape route.

18. The evacuation method according to claim 17, characterized in that the analysis processing includes crowdedness degree estimation, people detection, people flow estimation, body posture detection, abnormal sound analysis and/or video classification analysis.

19. The evacuation method according to claim 17, characterized in that the people's behavior statistic information data include people crowdedness degree, people flow mode, people's moving speed and/or people's falling degree.

20. The evacuation method according to claim 17, characterized in that after the video information or audio and video information is subjected to analysis processing, any of the video information or audio and video information is stored in a terminal.

21. The evacuation method according to claim 17, characterized in that, in the step of dynamically and optimally generating the escape route, the method further comprises the step of dynamically and optimally generating the escape route at the same time based on firefighting apparatus state information.

22. The evacuation system according to claim 17, characterized in that the escape route is computed based on a shortest route algorithm or a shortest time algorithm.
